(19) United States
(12) Patent Application Publication
(10) Pub. No.: US 2014/0175986 A1
(43) Pub. Date: Jun. 26, 2014

(54) Method Of Operating A Lighting System

(71) Applicant: MA LIGHTING TECHNOLOGY GMBH, (US)

(72) Inventors: Michael Adenau, Wurzburg (DE); Gerhard Krude, Altertheim (DE)

(73) Assignee: MA LIGHTING TECHNOLOGY GMBH, Waldbuttelbrunn (DE)

(21) Appl. No.: 13/778,953

(22) Filed: Feb. 27, 2013

(30) Foreign Application Priority Data
Dec. 20, 2012 (DE) 102012223919.7

(51) Int. Cl. H05B 33/08

(52) U.S. Cl. CPC H05B 33/0869
USPC 315/151

(57) ABSTRACT

A method for operating a lighting system includes a) selecting a color light source; b) emitting a color light signal with the primary color of the selected color light source; c) determining spectral data of the selected color light source using a spectrometer; d) storing the measured spectral data for describing a wavelength spectrum of the selected color light source in the digital memory of a lighting control console; and e) repeating the method steps a) to d) for multiple color light sources of the lighting system.

### CROSS REFERENCE TO RELATED APPLICATION

The present application claims the benefit of German Patent Application No. 10 2012 223 919.7 filed Dec. 20, 2012, which is fully incorporated herein by reference.

### STATEMENT REGARDING FEDERALLY SPONSORED RESEARCH OR DEVELOPMENT

Not applicable.

### FIELD OF THE INVENTION

The invention relates to a method for operating a lighting system.

### BACKGROUND OF THE INVENTION

For instance, but by no means exclusively, known lighting systems are used for lighting concert and theater stages. Said lighting systems comprise lighting control consoles for controlling the lighting systems. Within the lighting control console, a digital processor and a digital memory are provided in order to enable digital signal processing. By means of the lighting control console, control data can be generated, managed and stored in order to be able to control the various light sources of the lighting system. The lighting control consoles comprised by known lighting systems can control up to several thousand different light sources and can create a predetermined lighting scenario under program control.

In addition, the lighting system comprises several color light sources which are each able to emit color light signals in a specific primary color. A color light source in accordance with the invention is in particular characterized in that each of these color light sources can be actuated individually by the lighting control console via a separate control channel. As a result, it is thus possible to mix the individual color light signals of the different color light sources, using a variable mixture ratio, to obtain a mixed light. The result of mixing different color light sources with a different primary color each is that basically any mixed light color can be obtained by modifying the mixture ratio.

Furthermore, the lighting system comprises at least one spectrometer which is installed as a stationary unit or connected to the lighting system when needed. Here, the spectrometer enables measuring the wavelength spectrum of a color light signal and passing on the corresponding spectral data.

With known lighting systems comprising multiple color light sources which can each be actuated individually via separate control channels in order to enable generating mixed light of different colors by modifying the mixture ratio, there is the problem that the primary colors respectively emitted by the color light sources are assumed to correspond to a set standard. If, for instance, a multicolor spotlight with a plurality of LED lights in the three primary colors red, green and blue is used, wherein all red LEDs are actuated via a common first control channel, all green LEDs via a common second control channel and all blue LEDs via a common third control channel, it is generally presumed when actuating such a multicolor-capable LED spotlight that the primary colors of the spotlight, red, green and blue, are emitted in a predetermined intensity with a set standard wavelength, red usually with 700 nm, green with 546 nm and blue with 435 nm. For mixing the different primary colors when generating mixed light, a mixing chart, which is based on the wavelengths of the standard primary colors, is then used. If, for instance, a yellow mixed light is to be emitted by such an RGB spotlight, the control channels for the red and the green color light sources are set to full output whereas the control channels for the blue color light sources are set to zero output.

However, during practical operation of lighting systems with various color light sources, it can be seen that the color light sources of the different spotlights often do not correspond to the standard light colors, but rather deviate from normal standards. For instance, the deviation can be that the red light emitted by the light source does not correspond to the standard wavelength of 700 nm, but that the color light source emits red light with, for instance, a wavelength of 690 or 680 nm. Another possible deviation is that the intensity of the light emitted by a color light source does not correspond to the standard intensity. If such deviant color light signals are subsequently mixed with other color light signals in order to obtain a colored mixed light, the result does not meet the standard expectations with respect to the color effect. Instead, a mixed light is obtained whose color value deviates more or less from the color value expected according to the mixing chart used. This deviation from the expected color value of the mixed light is particularly inconvenient when multiple sources of mixed light are to emit mixed light of the same color value, respectively. If each of the individual sources of mixed light, which, for instance, respectively consist of three color light sources, deviates only slightly from the expected standard value in each case, the color light signals emitted by the different sources of mixed light are not identical and there are undesired color deviations.

The deviations of the primary colors emitted by the color light sources with respect to the expected standard light colors can be due to the type or the age of the device, for instance. Other reasons for deviations in the color of the color light sources can be dirt in or on the device or the use of filters.

Therefore, in order to enable a realization of exact color effects when mixing mixed light from multiple primary colors while using a lighting system, the method according to the invention is proposed.

### SUMMARY OF THE INVENTION

Here, a primary color according to the invention can be basically any color in the spectrum of visible light. Particularly suitable are, however, primary colors which are based on standardized color models, in particular the RGB color model with the primary colors red, green and blue or the CMY color model. The method according to the invention is characterized in that one control channel is assigned to each primary color, which can in principle be defined freely. If a particular control channel is actuated, colored light in the corresponding primary color is emitted.

The lighting system used when carrying out the method according to the invention has to comprise at least three separate control channels via which at least three color light sources of different primary colors can be actuated. This is because by modifying the mixture ratio when mixing color light of three different primary colors, different mixed colors can be generated within one specific color space. As a matter of course, it is also possible to use more than three primary colors. For instance, adding the supplementary primary color amber to an RGB color mixing system enables expanding the color space of the mixed colors that can be generated by modifying the mixture ratio.

The fundamental idea of the method according to the invention is the recognition of the fact that technical color light sources, for instance the different LED lights of a multicolor spotlight, in reality never exactly correspond to the expected standard light colors. Depending on the color light source used, deviations in the color of the color light sources with respect to the standard light colors always have to be accepted instead. When operating the lighting system for illuminating a stage or a concert hall, mixing of mixed light colors with a single mixing chart therefore cannot result in exact color effects with the same color light result in each case. In order to avoid this problem, a calibration process is initially carried out according to the invention before the actual lighting function of the lighting system is implemented. In the course of this calibration process, initially only one color light source is selected at a time and is actuated by the lighting control console by the transmission of an actuating command via the corresponding control channel such that the color light source emits a color light signal in the primary color which has been predetermined in the design of the color light source. The spectral data of the color light signal emitted by the color light source are subsequently measured by means of a spectrometer. The characteristics of the color light of the color light source are clearly defined by these spectral data.

After measuring the wavelength spectrum, the derived spectral data are stored in the digital memory of the lighting control console. The stored spectral data are clearly assigned to the respective color light source measured so that later on, when accessing the data set for the color light source, the assigned spectral data can be reaccessed at any time. The method steps a) to d) are subsequently repeated for several color light sources of the lighting system so that the result is that spectral data of the color light emitted by the color light sources, which are respectively assigned to a plurality of color light sources, are stored in the digital memory of the lighting control console.

By means of measuring and storing the spectral data of the color light sources according to the invention, it is possible during the actual operation of the lighting system to factor the characteristics of the different color light sources exactly in when mixing mixed light. In other words, this means that mixing of the different color light sources is not carried out by using one single mixing chart for all color channels any more, but rather that the mixture ratio for generating a particular mixed light is calculated by evaluating the spectral data of the color light sources provided for mixing.

In the field of lighting technology, it is distinguished between additive color mixing models, in particular the RGB color mixing model, and subtractive color mixing models, in particular the CMY color mixing model. The basic principle of color mixing in additive color mixing models is mixing color light which is directly emitted by a color light source, for instance by LED light fixtures. Color mixing in subtractive color mixing models is based on mixing color light which is generated by color filtering or color reflection of the light emitted by a light source. The method according to the invention can be used in the case of mixing mixed colors on the basis of an additive as well as a subtractive color mixing model.

In order to achieve a color light result as exact as possible, it is particularly advantageous if not only a part of, but basically all the color light sources in the lighting system are measured with respect to their wavelength spectra and if the derived spectral data are stored in the data memory of the lighting control console.

With known lighting devices, in particular LED spotlights, often a common actuation of a plurality of color light sources having the same primary color each is provided via a common control channel. This means in consequence that all color light sources, in particular all LEDs, of the same primary color are turned on and off together or that their light intensity is increased or decreased at the same time. In these cases, it is particularly advantageous if all color light sources actuated via a common control channel are activated at the same time when the spectral data are determined and if the wavelength spectrum of the color light emitted by all these color light sources at that time is measured by means of the spectrometer.

The type of color light source measured by means of the method according to the invention, with the corresponding spectral data being stored in the lighting control console, is basically optional. The method according to the invention offers particular advantages if so-called multicolor lights, which comprise at least three control channels for controlling at least three color light sources in at least three different primary colors, in particular in the colors red, green and blue, are utilized in the lighting system. Multicolor lights of this type, which are often designed as LED panels and often comprise a plurality of red, green and blue LEDs, are basically suitable for emitting mixed colors in any color within a specific color space, wherein the color emitted in each case is chosen by selecting the mixture ratio between the three primary colors. For carrying out the method according to the invention with multicolor lights of this type, the different control channels for the different primary colors of the multicolor light are actuated one after the other and only one at a time, and the wavelength spectrum of the color light on the different control channels is measured by means of the spectrometer. If a mixed light of a specific color is to be generated by means of a multicolor light of this type at a later stage, the mixture ratio required in each case is calculated taking into account the stored spectral data on the three color light control channels. The multicolor light has to comprise at least three control channels for controlling at least three color light sources in at least three different primary colors. As a matter of course, however, it is not only possible, but also reasonable in many cases to include more than three separate control channels with different primary colors correspondingly assigned. For instance, RGB lights often have an additional color channel with which LEDs in the primary color amber are actuated. Multicolor lights with five, six, seven or more separate control channels and with a corresponding number of different primary colors are also conceivable. With each additional control channel and the corresponding increase in primary colors available when mixing the colors, the possibilities of variation when mixing the colors and the color space to be displayed by mixing the colors are expanded.

The method according to the invention is extremely relevant if, for instance, a stage is to be illuminated by means of multiple multicolor lights in exactly the same color in each case. In order to make it possible that all multicolor lights actually generate a color light with the same color effect, in the lighting control console the mixture of the color signals of the three color light sources correspondingly assigned is calculated for each multicolor light taking into account the spectral data of the color light sources in the different multicolor lights. In other words, this means that each multicolor light is actuated with a mixture ratio of the respectively three primary colors which is individually adjusted such that the mixed light emitted by each multicolor light exactly corresponds to the predetermined light color. In that case, the mixed light, which is then joined on the stage again, basically does not deviate from the predetermined light color any more so that the mixed light of all multicolor lights used achieves the same color effect.

Another advantageous method variant of the method according to the invention arises with lighting systems which use at least one color filter element additionally. This is because, if the mixed light generated by the different color light sources by mixing the respective primary color is filtered through a color filter element, unexpected and often undesirable color effects may be the result. If, for instance, the mixed light is mixed from a color light with a particularly long wavelength and from a color light with a particularly short wavelength, the resulting mixed light has a light color corresponding to a medium wavelength. If this mixed light is subsequently passed through a color light filter which, for instance, only filters out color light with a particularly short or a particularly long wavelength, it could be expected that the mixed light is not influenced by the color filter due to its medium wavelength. As the mixed light is, however, mixed from short and long wavelength color light, the short wavelength color light will be filtered out of the mixed light and the long wavelength color light component remains. In order to avoid such effects, it is therefore particularly advantageous if color filter elements used in the lighting system are measured with respect to the wavelength spectrum respectively filtered out and if the corresponding spectral data are stored in the digital memory of the lighting control console. If a mixed light mixed from multiple color lights is subsequently radiated through said color filter, by evaluating the spectral data of the color light sources used and the spectral data of the color filter element used, it can be calculated in advance which light color will result after passing through the color filter element.

Furthermore, it is particularly advantageous if, in case the lighting system also takes into account reflective elements, for instance costumes, stage properties, parts of the stage set or special reflectors, the spectral performance of these reflective elements is also measured and stored. This is because, when mixed light is reflected at reflective elements, specific wavelength ranges of the mixed light are usually absorbed at the reflector. In order to be able to predict the color characteristics of the mixed light after reflection at the reflective element, it is therefore particularly advantageous if the wavelength spectrum of the reference light reflected by the reflective element is determined by measuring with the spectrometer and if the corresponding spectral data are stored in the digital memory of the lighting control console.

The spectral data of the measured wavelength spectrum can be determined in basically any manner desired. The result is particularly exact if the entire spectral curve of the color light signal emitted by a color light source is measured by means of the spectrometer and if this spectral curve is subsequently digitized. The digitized spectral curve can then be stored in the form of a table in the digital memory of the lighting control console after having been assigned to the corresponding color light source.

Alternatively to completely digitizing the entire spectral curve, the relative maxima of the measured spectral curve can also be determined as spectral data and stored in the digital memory. Although this results in the data being coarsened, it is sufficient for a plurality of applications if at least the maxima of the measured spectral curve are available for information on the color light characteristics of the color light source.

Various features of the invention are schematically represented in the drawings and will be explained for exemplary purposes hereinafter.

### BRIEF DESCRIPTION OF THE DRAWINGS

In the drawings:

FIG. 1 shows the function of human color perception when the retina in the eye is stimulated with mixed light which is mixed from different color light components;

FIG. 2 shows the biometric illustration of a color space for determining the color stimulus perceived by humans during irradiation with a mixed light from three primary colors;

FIG. 3 shows a schematically represented color chart for a geometric illustration of the color perception when three primary colors are mixed (left side) and an assigned color mixing chart (right side);

FIG. 4 shows a schematically represented illustration of the generation of metameric colors;

FIG. 5 shows a schematically represented lighting system for use with the method according to the invention;

FIG. 6 shows the detail Z from the multicolor spotlight of the lighting system according to FIG. 5;

FIG. 7 shows the wavelength spectrum of the colored color light sources of a first multicolor spotlight of the lighting system according to FIG. 5;

FIG. 8 shows the wavelength spectrum of the color light sources in a second multicolor spotlight of the lighting system according to FIG. 5;

FIG. 9 shows the wavelength spectrum of the color light sources in a third multicolor spotlight of the lighting system according to FIG. 5;

FIG. 10 shows the schematic illustration of the different mixed light colors for the multicolor spotlights of the lighting system according to FIG. 5;

FIG. 11 shows the detail Z from a modified multicolor spotlight;

FIG. 12 shows the wavelength spectrum of the colored color light sources of the modified multicolor spotlight according to FIG. 11;

FIG. 13 shows the lighting system according to FIG. 5 using additional color filter elements in front of the multicolor spotlights;

FIG. 14 shows the wavelength spectrum of a color light source in the medium visible wavelength range;

FIG. 15 shows the wavelength spectrum of two color light sources for mixing a color light in the medium wavelength spectrum corresponding to the color light source according to FIG. 12;

FIG. 16 shows the wavelength spectrum of the color light source according to FIG. 12 additionally using a color light filter;

FIG. 17 shows the wavelength spectrum of the two color light sources according to FIG. 15 additionally using the color light filter according to FIG. 16;

FIG. 18 shows the lighting system according to FIG. 5 additionally using a reflective element.

### DETAILED DESCRIPTION OF THE EXAMPLE EMBODIMENTS

Before describing the actual invention, the following is to provide a brief outline of the background of human color perception which is the basis of the technical teaching of the method according to the invention. This outline is by no means complete, but rather is supposed to explain the principles of color perception.

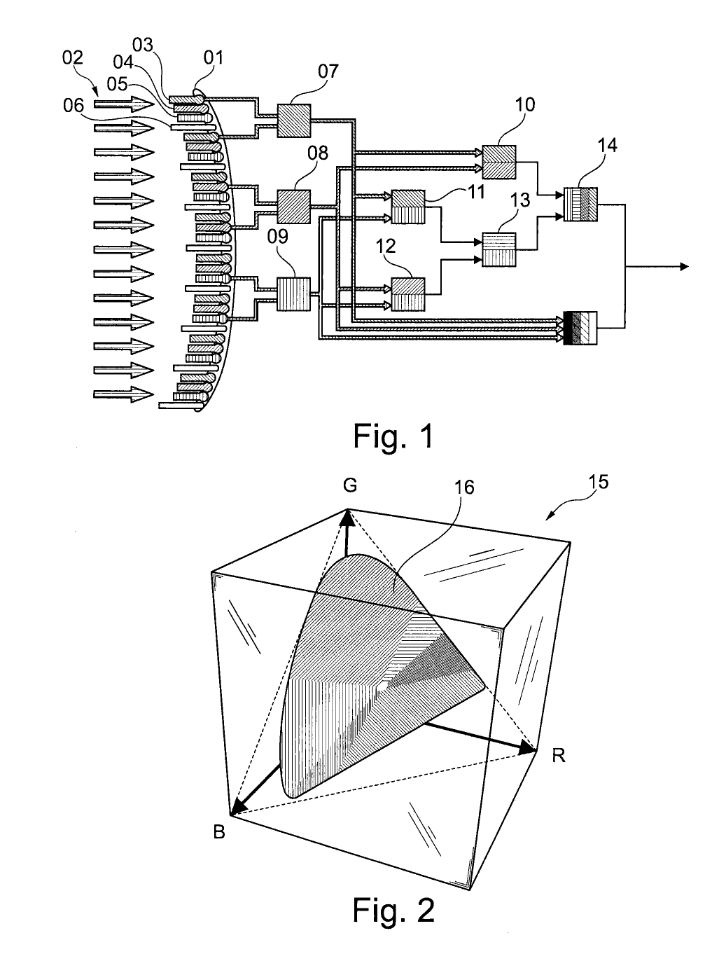

FIG. 1 schematically represents the functioning of the nerve cells in the retina 01 of the human eye under stimulation with a color light signal 02. In the retina 01 of the human eye, there are essentially four different types 03, 04, 05 and 06 of light-sensitive receptor cells. The receptor cells 03, 04 and 05 serve for perceiving color light stimuli. At that, the receptor cells 03 can distinguish color light stimuli in the range of red light, the receptor cells 04 can distinguish color light stimuli in the range of green light and the receptor cells 05 can distinguish the color light stimuli in the range of blue light, each with significantly different sensitivity. The receptor cells 06, however, serve the purpose of the so-called mesopic vision without distinction of colors. For understanding the invention, color light perception using the different receptor cell types 03, 04 and 05 is particularly important. When color stimuli are processed in the human eye and brain, initially the color stimuli of multiple receptor cells 03, of multiple receptor cells 04 and of multiple receptor cells 05 are respectively bundled and joined to a resulting red light stimulus 07, a green light stimulus 08 and a blue light stimulus 09. The resulting color light stimuli 07, 08 and 09 are subsequently further processed to a combined red-green light stimulus 10, a combined red-blue light stimulus 11 and a combined green-blue light stimulus 12. After another intermediate stage with the combined light stimulus 13, the final result is a combined red-green-blue light stimulus 14 which reflects the mixture ratio of the red, green and blue light in the color light signal 02 in a characteristic manner. The combined RGB light stimulus 14 is subsequently transmitted to the brain for further processing. In the brain, a specific color perception from the spectrum of visible light in the range between 400 nm and 750 nm is assigned to the combined RGB light stimulus 14. In other words, this means that, depending on the mixture ratio of the components red, green and blue in the combined RGB light stimulus 14, a specific color perception is triggered in the brain. If, for instance, the color light signal 02 contains as much red as green light, but no blue light at all, a color perception of yellow color is triggered in the brain by the combined RGB light stimulus 14.

For understanding the invention it is essential that, by different color light mixtures which hit the retina in the form of color light signals 02, respectively assigned color perceptions are triggered in the brain.

The background which is physiologically represented in FIG. 1 can be represented in the color space illustrated in FIG. 2 in simplified terms. Here, the color space 15 is spanned between the three primary colors red, green and blue, wherein each color light signal can be represented as a vector in this color space. The color perception of the human brain is represented in the color space 15 as the color chart 16 which comprises a section of the angular half-plane in the color space 15. Here, every point of the color chart 16 represents a specific color in the range between 400 nm and 750 nm, which can be perceived by the human brain. If three color light signals in the primary colors red, green and blue are now emitted together, this can be understood as a vector addition in the color space 15. The light color perceived by the human brain when receiving this mixed signal corresponds to the point at which the addition vector from the individual vectors red, green and blue hits the color chart 16. Here, it is immediately obvious that the different points on the color chart 16 can respectively be realized by means of different combinations of the primary color vectors. In other words, this means that, in order to achieve a specific color perception in the human brain, different color mixtures from the primary colors red, green and blue and also from the mixture of other primary colors are possible in each case.

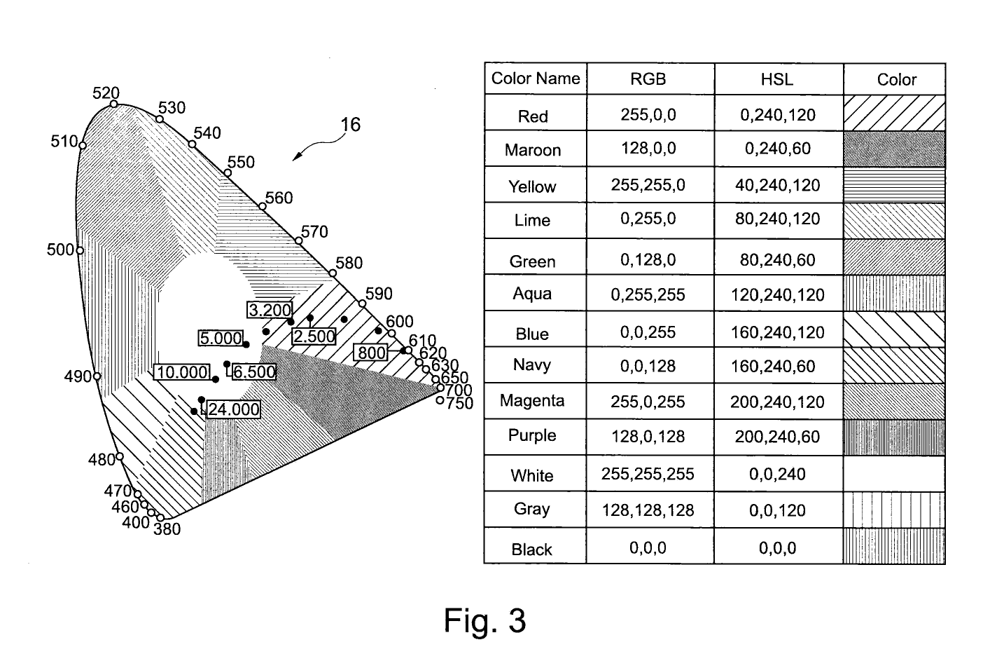

FIG. 3 displays the color chart 16 (left side) and an assigned color mixing chart (right side). Here, every point in the color chart 16 describes a specific color perception in the human brain. The RGB column in the color mixing chart represents the required mixture ratio of the red, green and blue components, broken down into 256 substeps for generating different light perceptions by mixing the primary colors red, green and blue. All other mixture ratios result as intermediate steps. If all three primary colors red, green and blue are used, a color light perception follows which is increasingly grey and white in the end. If all three primary colors are turned on with equal intensity, the resulting light is white. If, on the other hand, all color light sources are turned off at the same time, a black color perception results. As an alternative to the RGB color mixture, an HSL color mixing system can also be used.

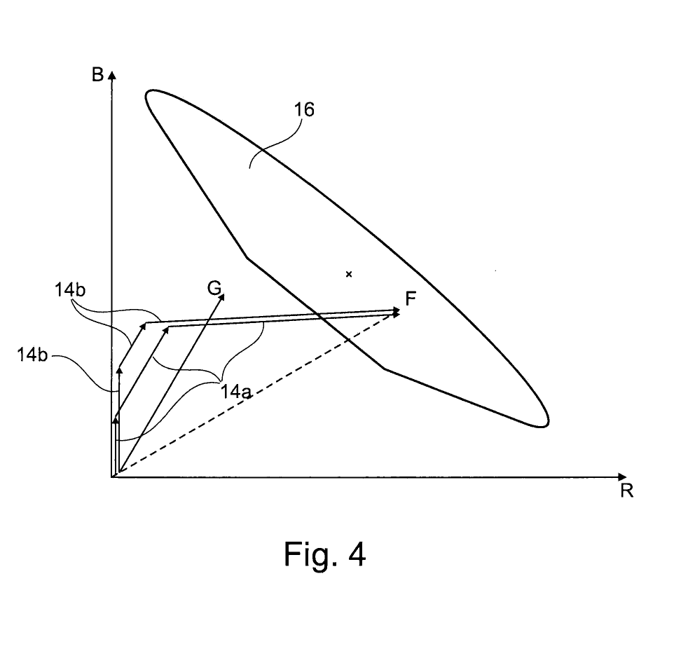

FIG. 4 again schematically explains the function of color light perception in the human brain when it is stimulated with a mixed light from three primary colors. If, for instance, the eye receives a combined RGB light stimulus 14a, the result is a color perception with the color F. Here, the color F is characterized by the contact point of the combination vector of the primary color vectors in the combined RGB light stimulus 14.

If the retina now alternatively receives a combined RGB light stimulus 14b, which has a different color light mixture of the primary colors red, green and blue, this can nevertheless lead to the same color perception of the color F in the brain. Even though the light stimulus in the primary color blue is more intense in the combined light stimulus 14b, this more intense blue component is counterbalanced by a less intense green component and a correspondingly more intense red component so that the result is that the vector addition hits the color chart 16 at the same point. In consequence, it has to be stated that a specific human color perception is not clearly assigned to a specific color combination of the primary colors. Instead, similar color sensations can be created in the human brain by means of different mixtures of the different primary colors.

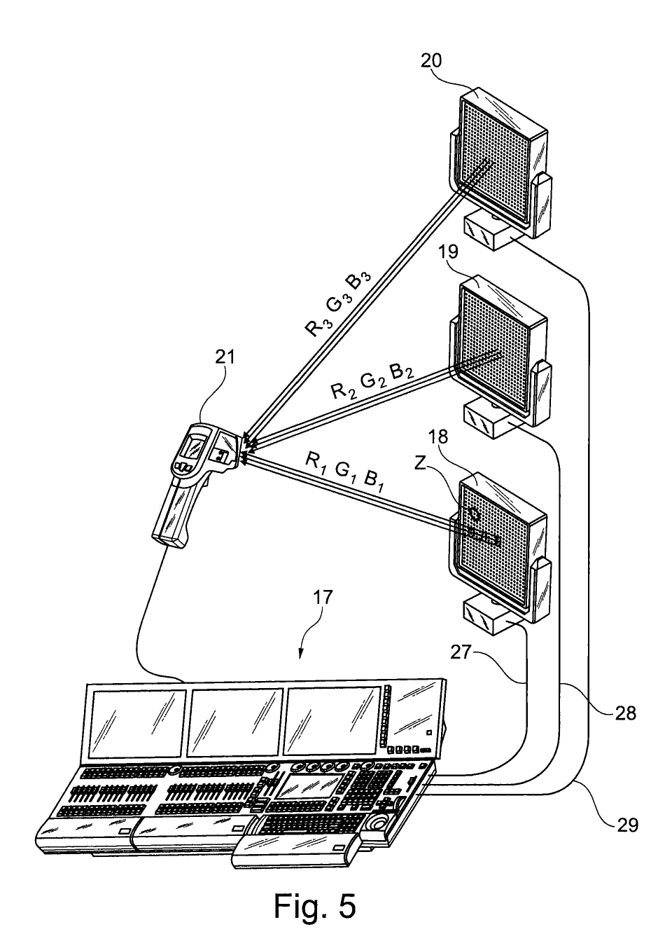

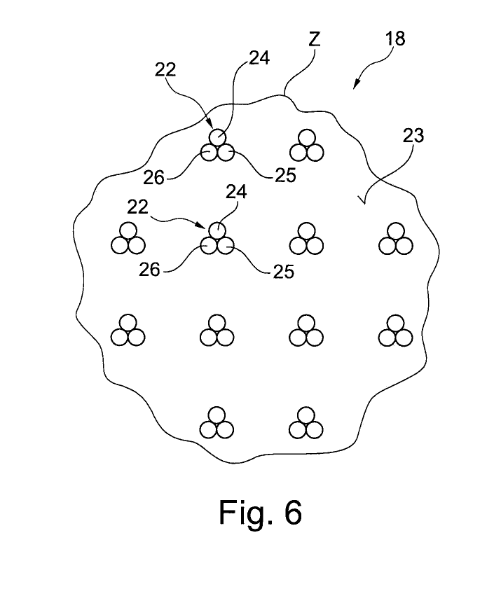

FIG. 5 shows a schematically represented lighting system, comprising a lighting control console 17, three multicolor spotlights 18, 19 and 20 and a spectrometer 21. The multicolor spotlights 18, 19 and 20 are formed as LED panels. For generating color light signals, the multicolor spotlights 18, 19 and 20 each comprise pixels 22 (see FIG. 6) on the side of the spotlight, which again consist of a red LED, a green LED and a blue LED, respectively. For clarification, the detail Z is shown enlarged in FIG. 6.

Thus, the pixel surface of the multicolor spotlights 18, 19 and 20 shown enlarged in FIG. 6 on the side of the spotlights 23 comprises a plurality of pixels 22 with one red LED 24, one green LED 25 and one blue LED 26 each. Here, the LEDs 24, 25 and 26 of a pixel 22 are disposed so close to each other on the side of the spotlight 23 that they cannot be perceived as individual points by the human eye anymore, provided the distance to the multicolor spotlight 18, 19 or 20 is large enough. All red LEDs 24 of one of the multicolor spotlights 18, 19 and 20 are assigned to a common control channel here. When this control channel is actuated, the intensity of all red LEDs is thus increased at the same time or they are dimmed at the same time. In the same way, all green LEDs 25 and all blue LEDs 26 in the different multicolor spotlights 18, 19 and 20 are respectively assigned to their own separate control channel. The various control channels are controlled via the cables 27, 28 and 29 from the lighting control console 17. Consequently, this means in other words that three control channels with the primary colors RGB are transmitted from the lighting control console 17 to the multicolor light 18 via the cable 27. In the same way, via the cables 28 and 29 three control channels for the primary colors RGB are respectively transmitted between the lighting control console 17 and the multicolor spotlights 19 and 20.

By correspondingly actuating the lighting control console, the multicolor spotlights 18, 19 and 20 can thus be prompted to emit color light signals in the primary colors red, green and blue in a mixture ratio R1, G1, B1 (multicolor spotlight 18), R2, G2, B2 (multicolor spotlight 19) and R3, G3, B3 (multicolor spotlight 20), respectively, which can be selected in each case. Depending on the mixture ratio of the three primary colors red, green and blue, the color light emitted by the multicolor spotlights 18, 19 and 20 is perceived by humans in a specific color in the wavelength range between 400 nm and 750 nm. This means that humans, when looking at the multicolor spotlights 18, 19 and 20, perceive their mixed light not as a mixture of red, green and blue light, but as a mixed light of a specific color in the range between ultraviolet and infrared. Which color is perceived in the human perception range is determined by the mixture ratio.

As is further shown in FIG. 6, the lighting system also comprises a spectrometer 21. In order to carry out the method according to the invention with the lighting system shown in FIG. 5, initially only the first control channel of the multicolor spotlight 18 is actuated and only the color light of all red LEDs is emitted. This R1 color light signal is received and measured by the spectrometer 21. Subsequently, all red LEDs in the multicolor spotlight 18 are turned off and all green LEDs are turned on. The G1 color light signal is then measured in the same way and, in the end, the B1 color light signal is measured by turning on all blue LEDs solely. Subsequently, by respectively turning on only the red, green and blue LEDs in the multicolor spotlights 19 and 20, the R2, G2, B2 color light signals and the R3, G3 and B3 color light signals are also measured. In each case, the wavelength spectra in the primary colors red, green and blue measured by means of the spectrometer 21 are respectively transmitted to the lighting control console 17 after having been measured, and are stored in a digital memory. The spectral data are stored in such a way that the spectral data of R1, G1 and B1 are assigned to the multicolor spotlight 18, the spectral data of R2, G2 and B2 are assigned to the multicolor spotlight 19 and the spectral data of R3, G3 and B3 are assigned to the multicolor spotlight 20.

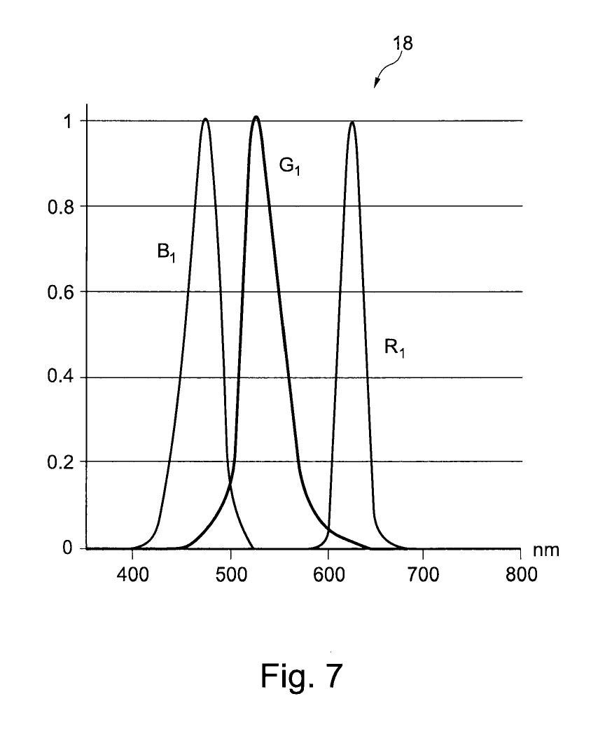

FIG. 7 shows the spectral curves R1, G1 and B1 of the multicolor spotlight 18 stored as spectral data in the lighting control console 17.

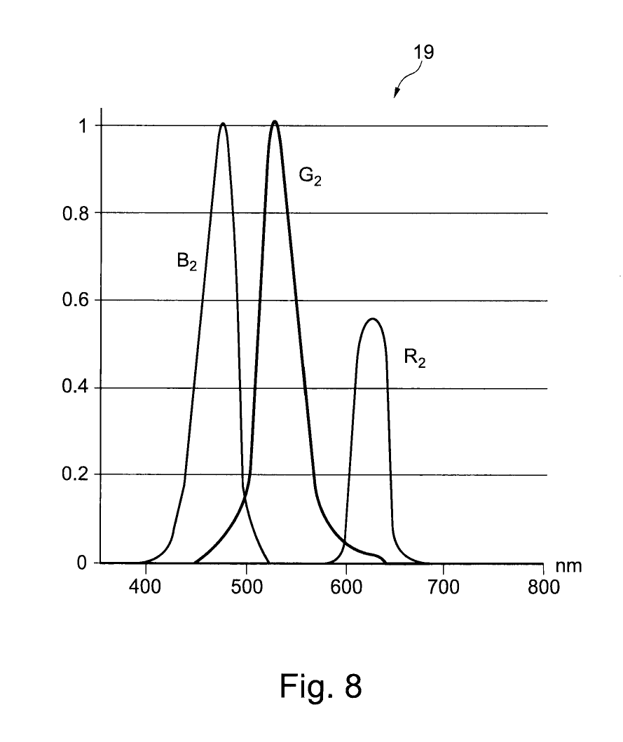

FIG. 8 shows the spectral curves R2, G2 and B2 of the multicolor spotlight 19 stored as spectral data in the lighting control console 17.

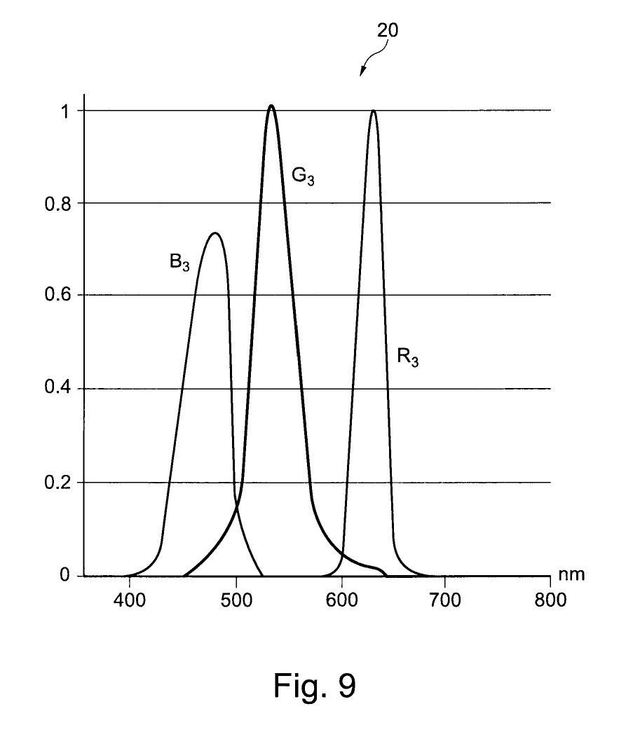

FIG. 9 shows the spectral curves R3, G3 and B3 of the multicolor spotlight 20 stored as spectral data in the lighting control console 17.

For illustrating the invention, it is to be assumed in the following that the multicolor spotlight 18 with respect to its color quality corresponds to standard light according to the color mixing chart 17. In other words, this means that, when the multicolor spotlight 18 is actuated with the mixture ratios according to the color mixing chart 17, corresponding mixed colors according to this chart are the result. In addition, it is to be assumed that the red LEDs in the multicolor spotlight 19 do not emit sufficient light intensity as is the case in the multicolor spotlight 18. In the illustration according to FIG. 8, this is shown in the reduced beam intensity of the spectral curve R2. In other words, this means that the red LEDs in the multicolor spotlight 19 cannot emit red light with the same radiation intensity as the blue and green LEDs.

It is further to be assumed for the third multicolor spotlight 20 that the blue LEDs, for instance, do not emit blue light with the same radiation intensity as the green or the red LEDs. In FIG. 9, this is shown in the reduced maximum of the spectral curve B3.

If the three multicolor spotlights 18, 19 and 20 are now actuated in each case with an equal mixture ratio according to the color mixing chart 17, different mixed colors result for the multicolor spotlights 19 and 20 than for the multicolor spotlight 18. This is because, due to the reduced intensity of red light with the multicolor spotlight 19 and the reduced intensity of blue light with the multicolor spotlight 20, respectively, the sum vectors of the addition from the three primary color vectors each result in different hit points on the color chart 16.

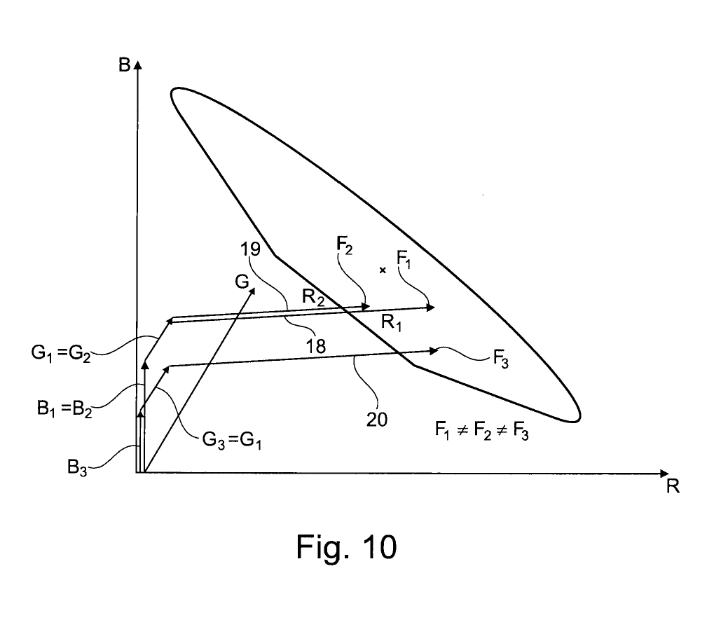

In FIG. 10, this concept is schematically represented. If the multicolor spotlights 18, 19 and 20 are actuated in the same way and with the same color mixture according to the color mixing chart 17, different mixed colors F1, F2 and F3 result. These differences are due to the reduced intensity of red light with the multicolor spotlight 19 and the reduced intensity of blue light with the multicolor spotlight 20, respectively. If, however, all multicolor spotlights 18, 19 and 20 are to emit the same mixed light in a predetermined mixed color F, the different multicolor spotlights 18, 19 and 20 have to be actuated with correspondingly adjusted mixture ratios of the primary colors red, green and blue. In order to be able to calculate the mixture ratio respectively required, the spectral curves which are stored in the lighting control console 17 according to the illustration in FIG. 7, FIG. 8 and FIG. 9 are evaluated, in particular integrated, and the respective mixture ratio is calculated. Only by means of storing, according to the invention, the spectral data according to the spectral curves represented in FIG. 7, FIG. 8 and FIG. 9, it is possible to actuate the multicolor spotlights 18, 19 and 20 such that, as a result, all multicolor spotlights emit a mixed light which triggers the same respective combined RGB light stimulus 14 in the human eye.

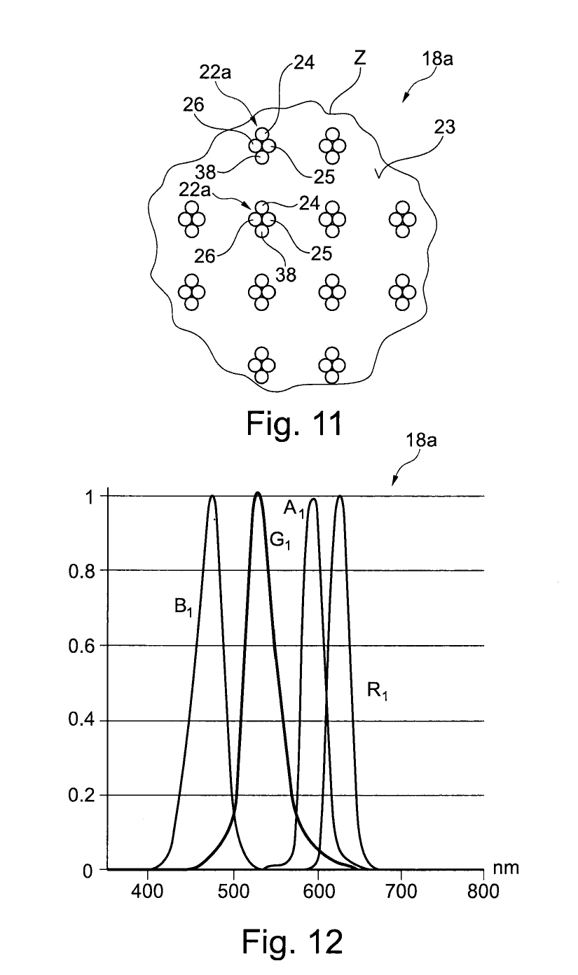

FIG. 11 shows the enlarged pixel surface of a modified multicolor spotlight 18a. On the side of the spotlight 23, it comprises a plurality of modified pixels 22a, each with a red LED 24, a green LED 25, a blue LED 26 and an additional amber LED 38. The LEDs 24, 25, 26 and 38 of a pixel 22a are again disposed so close to each other on the side of the spotlight 23 that they cannot be perceived as individual points by the human eye anymore, provided the distance to the multicolor spotlight 18a is large enough. With respect to its general configuration, the modified multicolor spotlight 18a corresponds to the configuration of the multicolor spotlight 18. Via an additional control channel, all additional amber LEDs 38 can be dimmed at the same time. By means of the additional primary color amber, with the modified multicolor spotlight 18a, mixed colors can be mixed in a larger color space.

FIG. 12 shows the spectral curves R1, G1, B1 and A1 of the modified multicolor spotlight 18a, which are stored in the lighting control console 17 as spectral data.

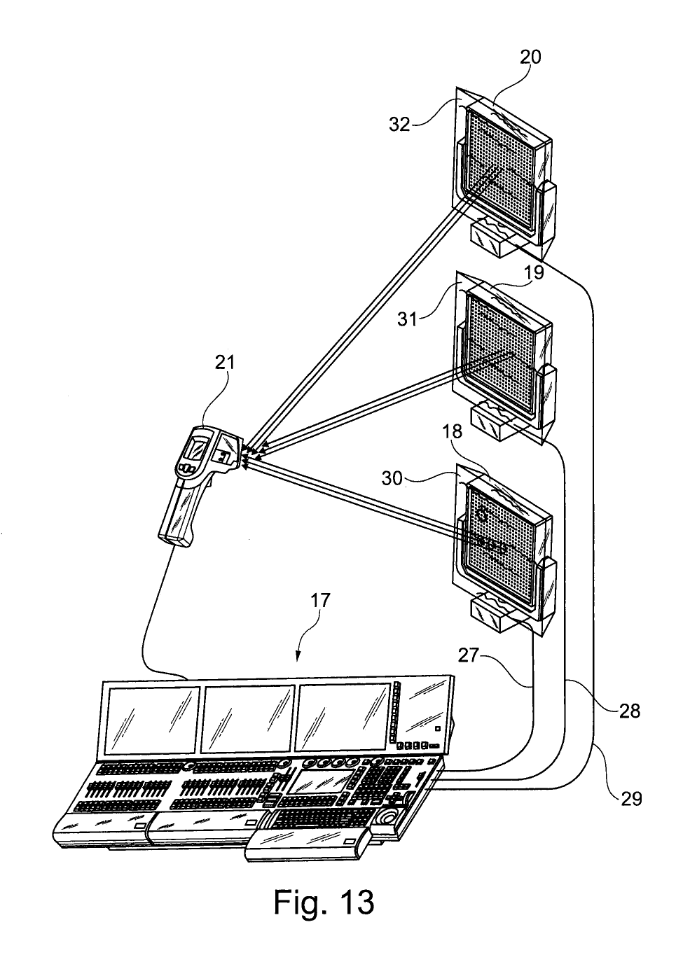

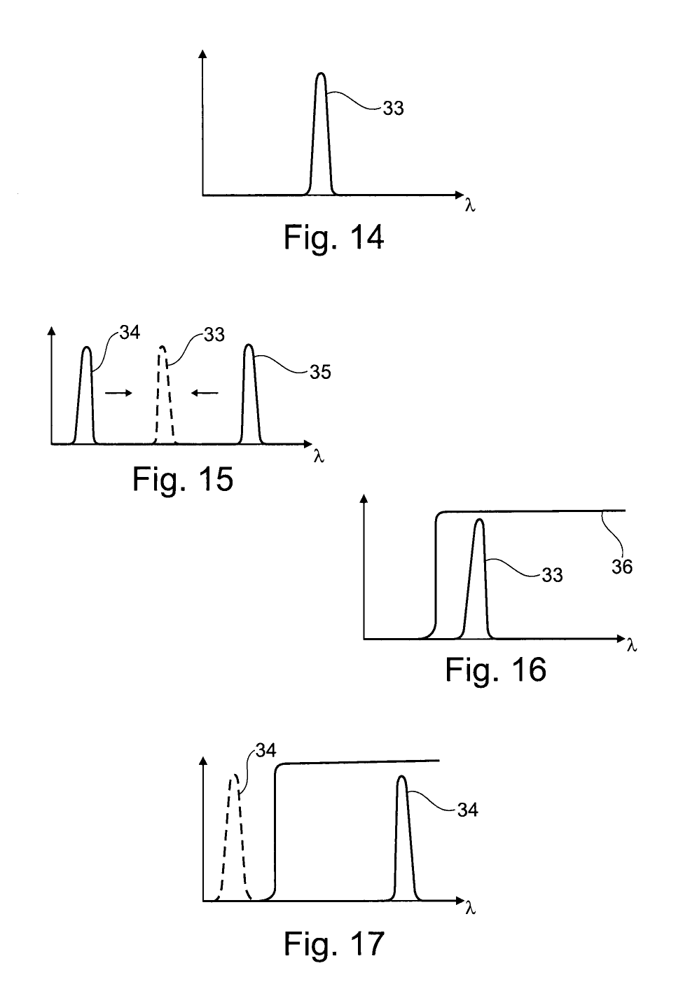

FIG. 13 shows the lighting system according to FIG. 5 with a method variant. With this method variant, color filter elements 30, 31 and 32 are disposed in front of the multicolor spotlights 18, 19 and 20, respectively. Subsequently, the spectral characteristics of the color filter elements 30, 31 and 32 are measured by the multicolor spotlights 18, 19 and 20 emitting a predefined reference light, the color light signal being measured by means of the spectrometer 21 after passing through the color filter elements 30, 31 and 32 and the corresponding spectral data being stored in the lighting control console 17. As a result, information is available on every color filter element 30, 31 and 32 in the lighting control console, stating which wavelength range is filtered out by the corresponding color filter element. In which way these data can subsequently be processed is explained by means of the illustrations in FIG. 14, FIG. 15, FIG. 16 and FIG. 17.

FIG. 14 shows the spectral curve of a color light signal in the medium wavelength range.

If a color stimulus is to be mixed from two primary colors corresponding to the color light according to FIG. 12, this can be done by mixing a color light signal with a short wavelength and a color light signal with a long wavelength.

FIG. 15 schematically represents the interferences of the short wavelength color light signal 34 and of the long wavelength color light signal 35, which results in a color stimulus in the human eye corresponding to the medium wavelength color light signal 33.

If a filter element with a short wavelength filtering characteristic is now disposed in front of a color light source with a medium wavelength color light signal 33, this results in the situation schematically shown in FIG. 16. The medium wavelength color light signal 33 easily passes through the color filter as the filter only filters off color light with a short wavelength.

FIG. 17, on the other hand, shows the situation when the same short wavelength color filter element 36 is disposed in front of a multicolor light with the combined color light signals 34 and 35. In this case, the short wavelength color light signal 34 would be filtered out by the filter element 36 and only the long wavelength color light signal 35 would remain. The color light stimulus perceived by the human eye would then only correspond to the long wavelength color light signal 35. In other words, when a specific color effect is pre-calculated, this means that, when color filter elements are used, their spectral data have to be measured and stored as well, as the color effect of the filter element depends on which mixture of primary colors is being used.

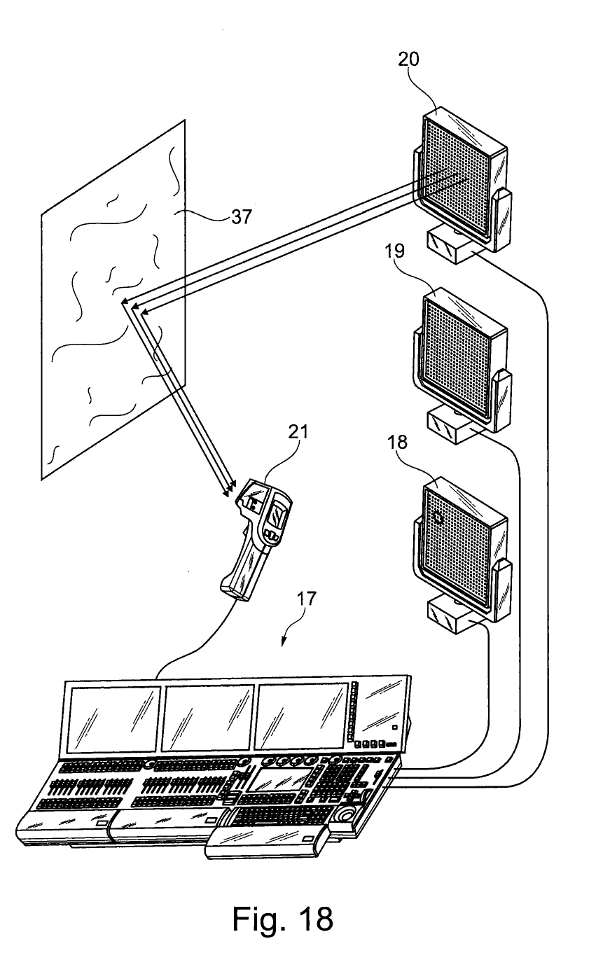

FIG. 18 shows the lighting system according to FIG. 5 when a reflective element 37 is used. In this case, a reference light signal is radiated at the reflective element 37 by means of the multicolor spotlight 20, for instance, and the light signal reflected at the reflective element 37 is measured by means of the spectrometer 21. The spectral data resulting from this are stored in the lighting control console 17 after having been clearly assigned to the reflective element 37. In this way, the color effect of reflective light effects can be pre-calculated by the lighting control console 17 if the reflective element 37 is used.

1. A method for operating a lighting system including at least one lighting control console for controlling the lighting system, wherein the lighting control console includes at least one digital processor and at least one digital memory which are suitable for generating, managing and storing data, multiple color light sources which respectively emit color light signals in at least three different primary colors, wherein the different color light sources can be actuated individually by the lighting control console via separate control channels in order to be able to mix the individual color light signals, using a modifiable mixture ratio, to obtain a mixed light, and a spectrometer with which the wavelength spectrum of a color light signal can be measured, said method comprising:
a) selecting a color light source and actuating said color light source by transmitting an actuating command via an assigned control channel from the lighting control console to the color light source;
b) emitting a color light signal with a primary color of the selected color light source;
c) determining spectral data of the selected color light source by measuring a wavelength spectrum of the colored color light signal using the spectrometer;
d) storing the measured spectral data for describing the wavelength spectrum of the selected color light source in the digital memory of the lighting control console; and
e) repeating method steps a) to d) for multiple color light sources of the lighting system.

2. The method according to claim 1, in which the multiple color light sources, which respectively emit color light signals in a specific primary color, are mixed in an additive manner when the mixed light is generated.

3. The method according to claim 1, in which the multiple color light sources, which respectively emit color light signals in a specific primary color, are mixed in a subtractive manner when the mixed light (F₁, F₂, F₃) is generated.

4. The method according to claim 1, in which spectral data of all color light sources of the lighting system are measured and stored in the digital memory of the lighting control console.

5. The method according to claim 1, in which multiple color light sources of the same respective primary color, are actuated via a common control channel at the same time, wherein the spectral data of these color light sources are measured by measuring a common wavelength spectrum of the color light signals of all color light sources actuated at the same time by means of the spectrometer.

6. The method according to claim 1, in which at least three color light sources which respectively emit color light signals with different primary colors, are disposed in a multicolor light, wherein a color of mixed light of the multicolor light is generated by mixing the color light signals of the three color light sources taking into account the spectral data which are assigned to the three color light sources.

7. The method according to claim 6, in which a light color to be generated is predefined for the mixed light in the lighting control console for multiple multicolor lights, wherein the mixture of the color light signals of the three color light sources which is required for generating said light color is calculated in the lighting control console for every multicolor light taking into account the spectral data of the color light sources in the different multicolor lights.

8. The method according to claim 1, in which the lighting system additionally includes at least one color filter element, wherein the color filter element is radiated through by a reference light source, and wherein the spectral data of the color filter element are determined by measuring the wavelength spectrum of the radiating color light signal and are stored in the digital memory of the lighting control console.

9. The method according to claim 1, in which the lighting system additionally includes at least one reflective element, wherein the reflective element is radiated at by a reference light source, and wherein the spectral data of the color filter element are determined by measuring the wavelength spectrum of the reflected color light signal and are stored in the digital memory of the lighting control console.

10. The method according to claim 1, in which the spectral data to be stored are derived from color light sources by digitizing the measured spectral curve.

11. The method according to claim 1, in which the spectral data to be stored are derived from color light sources by determining the relative maxima of the measured spectral curve.
